(19) United States
(12) Patent Application Publication
(10) Pub. No.: US 2003/0082417 A1
(43) Pub. Date: May 1, 2003

(54) Calibration process and apparatus for an electrochemical cell system

(76) Inventor: Mark A. Lillis, South Windsor, CT (US)

Correspondence Address: CANTOR COLBURN, LLP, 55 GRIFFIN ROAD SOUTH, BLOOMFIELD, CT, 06002

(21) Appl. No.: 10/065,373

(22) Filed: Oct. 10, 2002

Related U.S. Application Data
(60) Provisional application No. 60/342,867, filed on Oct. 25, 2001.

(51) Int. Cl. G01F 25/00; H01M 8/02

(52) U.S. Cl. 429/12; 204/628; 73/1.16

(57) ABSTRACT

In one embodiment, A hydrogen gas detector calibration system comprises: a mixing tube; a first conduit in fluid communication with a hydrogen-free gas, wherein the first conduit comprises a first orifice in fluid communication with the mixing tube; an electrolysis cell for generating hydrogen gas; a second conduit in fluid communication with the hydrogen gas, wherein the second conduit comprises a second orifice in fluid communication with the mixing tube; and the hydrogen gas detector in fluid communication with the mixing tube. In one embodiment, the process for calibrating a hydrogen gas detector comprises: introducing hydrogen-free gas to the hydrogen detector, wherein the hydrogen gas detector generates a first signal; introducing a known quantity of hydrogen gas from a hydrogen/water separator to the hydrogen gas detector, wherein the hydrogen gas detector generates a second signal corresponding to a concentration hydrogen; and calibrating the hydrogen gas detector based upon the first and second signals.

### CROSS-REFERENCE TO RELATED APPLICATIONS

This application claims priority to U.S. Ser. No. 60/342,867, filed Oct. 25, 2001, the entire contents of which are incorporated herein by reference.

### BRIEF DESCRIPTION OF THE RELATED ART

Electrochemical cells are energy conversion devices, usually classified as either electrolysis cells or fuel cells. An electrolysis cell typically generates hydrogen by the electrolytic decomposition of water to produce hydrogen and oxygen gases, whereas in a fuel cell hydrogen gas typically reacts with oxygen gas to generate electricity. In certain arrangements, the electrochemical cells can be employed to both convert electricity into hydrogen, and hydrogen back into electricity as needed. Such systems are commonly referred to as regenerative fuel cell systems.

While existing electrochemical cell systems are suitable for their intended purposes, there still remains a need for improvements, particularly regarding the calibration of the detectors used to monitor leakage of hydrogen gas, e.g., to meet government regulations. It is desirable to have a means to determine whether the output signal from the hydrogen detector is a valid measure of the gas concentration, as it is known that the sensitivity and accuracy of the hydrogen gas detectors drift overtime. Recalibration of the hydrogen gas detectors is periodically required to ensure accurate readings and safe operating conditions. Presently, calibration is performed manually. That is, an operator physically sprays control mixtures of air and hydrogen gases directly onto the gas detectors. The operator then manually calibrates the detector to ensure accurate readings during operation of the system. However, manual calibration requires an operator to physically make the necessary detector adjustments. Many locations where gas detection instruments are installed are difficult to reach, or pose other problems to achieve calibration such as their locations being classified as hazardous by the National Electrical Code (NFPA 70—National Electrical Code—1996 Edition). As such, certain operator skill and time are required to accurately and precisely calibrate the system. Even if periodic manual calibration of the detector is performed, the detector may still fail during the time interval between calibrations, and this failure will result in false gas concentration readings, or failure to respond when exposed to the hydrogen gas. Therefore, a need exists for an autocalibration apparatus and process to periodically calibrate the detectors to ensure their accuracy and precision without operator intervention.

### TECHNICAL FIELD

The present disclosure relates to electrochemical cell systems and more particularly, to a calibration process and apparatus for use with an electrochemical cell system.

### SUMMARY OF INVENTION

Disclosed herein are hydrogen gas detector calibration systems, processes for calibrating the hydrogen gas detector, processes for operating a hydrogen gas detector, and processes for operating an electrochemical system. In one embodiment, A hydrogen gas detector calibration system comprises: a mixing tube; a first conduit in fluid communication with a hydrogen-free gas, wherein the first conduit comprises a first orifice in fluid communication with the mixing tube; an electrolysis cell for generating hydrogen gas; a second conduit in fluid communication with the hydrogen gas, wherein the second conduit comprises a second orifice in fluid communication with the mixing tube; and the hydrogen gas detector in fluid communication with the mixing tube.

In one embodiment, the process for calibrating a hydrogen gas detector comprises: introducing hydrogen-free gas to the hydrogen detector, wherein the hydrogen gas detector generates a first signal; introducing a known quantity of hydrogen gas from a hydrogen/water separator to the hydrogen gas detector, wherein the hydrogen gas detector generates a second signal corresponding to a concentration hydrogen; and calibrating the hydrogen gas detector based upon the first and second signals.

In one embodiment, the process for operating an electrochemical system, comprises: calibrating a hydrogen gas detector; introducing water to an electrolysis cell; producing hydrogen; separating hydrogen from water in the hydrogen/water separator; introducing environmental gas disposed around electrochemical system components to the hydrogen gas detector; and determining the hydrogen concentration in the environmental gas.

In one embodiment, the process for operating a hydrogen gas detector comprises: automatically calibrating the hydrogen gas detector with a controller, wherein calibrating the hydrogen gas detector comprises exposing the hydrogen gas detector a hydrogen-free gas to determine a baseline, directing hydrogen gas from an electrochemical cell to a mixing tube to form a mixture having a known hydrogen concentration, exposing the hydrogen gas detector to the mixture to generate a signal corresponding to the known hydrogen concentration, and adjusting a reading of the hydrogen gas detector based upon the known concentration of hydrogen gas in the mixture; and automatically sampling an environment around the electrochemical cell system with the hydrogen gas detector.

Other features will be appreciated and understood by those skilled in the art from the following detailed description and drawings.

### BRIEF DESCRIPTION OF DRAWINGS

Referring now to the drawings, which are meant to be exemplary and not limiting, and wherein like elements are numbered alike in the several Figures:

FIG. 1 is a schematic diagram of a regenerative fuel system;

FIG. 2 is a schematic diagram of a hydrogen gas calibration apparatus for an electrochemical system;

FIG. 3 is a schematic diagram of a mixing tube for an electrochemical system; and

FIG. 4 is a schematic diagram of a mixing tube in accordance with another embodiment.

### DETAILED DESCRIPTION

In a calibration process for use with a hydrogen gas detector in an electrochemical system, the detector is calibrated with air and a known concentration of hydrogen gas mixed with the air. The hydrogen gas is generated within the system. Preferably, the air and hydrogen gas are at about the same pressure. More preferably, the air and hydrogen gas are at ambient pressure. The term “ambient pressure” as used herein is defined as the pressure within the encompassing atmosphere or environment of the electrochemical system. While the environment surrounding the components of the system is preferably maintained at or about atmospheric pressure, although certain systems may be maintained at higher or lower pressures.

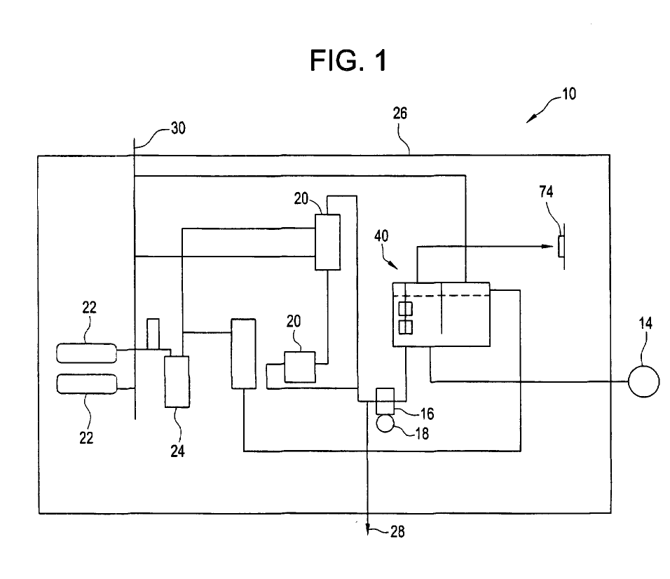

Referring now to FIG. 1, a schematic diagram of a regenerative fuel system 1 0 is depicted. Although a regenerative fuel system is shown, it should be understood that regenerative fuel cell systems are exemplary only, and other suitable electrochemical cell systems may employ fuel cells or electrolysis cells or combinations thereof, such as for example, those electrochemical cell systems available under the trade names UNIGEN®, HOGEN® and FUELGEN®, commercially available from Proton Energy Systems, Wallingford, Conn., as long as the electrochemical cell system includes a source of hydrogen gas.

The illustrated regenerative fuel system 10 includes, for example, a power supply (not shown), a process water source 14, heat exchanger(s) 16, fan(s) 18, cell stack(s) 20, pump(s) (not shown), hydrogen storage tanks 22, and a hydrogen dryer 24, water drain 28, vents 30, as well as sensors, valves, gages, filters, fans, controls, electrical equipment, and the like, preferably arranged in a compact configuration. Optionally, the fuel system 10 includes an enclosure 26 that typically employs a positive pressure air purge. The cell stacks are typically one of two types: fuel cell or electrolysis cell. The electrolysis cell generates hydrogen gas from process water for storage in the system whereas the fuel cell generates power as needed by reacting the stored hydrogen with oxygen to release energy and generate byproduct water. Accordingly, the system preferably further includes a water tank 40.

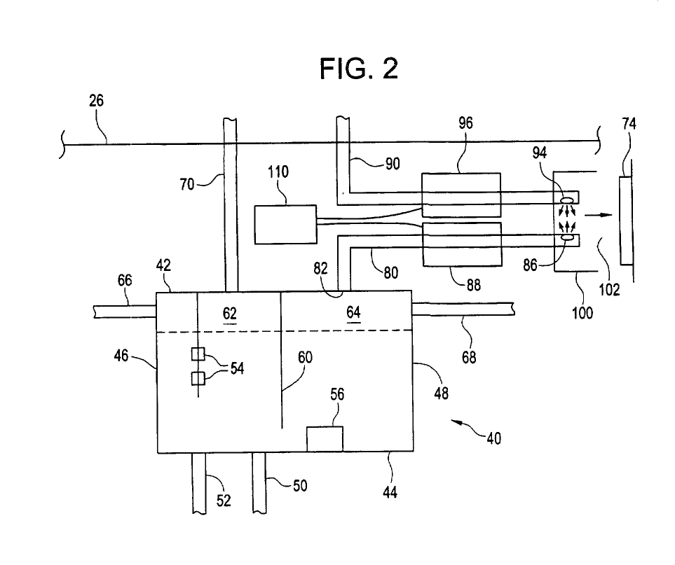

As shown in FIG. 2, the water tank 40 is enclosed and includes a top surface 42, a bottom surface 44, and sidewalls 46, 48, respectively. A water inlet 50 and a water outlet 52 are connected to the bottom surface 44. Level sensors 54 and a heater 56 are optionally disposed in the water tank 40. An optional gas impermeable partition 60 extends from the top surface 42 and divides an airspace located above the water level, such that there are two airspaces 62 and 64. Inlets 66, 68 are connected to the sidewalls 46, 48, respectively, and are in fluid communication, as shown, with airspaces 62, 64, respectively. Inlet 66 admits oxygen and water generated during electrolysis into the airspace 62 whereas inlet 68 admits hydrogen gas and water (protonic water) into the other airspace 64. Vent 70 is connected to the top surface 42 and in fluid communication with airspace 62. Vent 70 relieves any excess pressure generated within airspace 62. Optionally, the water tank 40 may comprise two or more separate tanks in fluid communication with each other (not shown).

The water tank further includes a conduit 80 with one open end 82 in fluid communication with the hydrogen gas contained in airspace 64. The other end of the conduit 80 includes at least one orifice 86. A circulation pump 88, or the like, may be connected to conduit 80 to flow the hydrogen gas contained in airspace 64 through the orifice 86. The hydrogen gas contained in airspace 64 is preferably at or about ambient pressure. Control of the flow can be by a number of methods, e.g., volume based or the like. The conduit 80 terminates in a mixing tube 100 having an open end 102 in fluid communication with the hydrogen gas detector 74. The end 102 of the mixing tube 100 is disposed in close proximity to the hydrogen gas detector 74 such that the detector is exposed to the flow of hydrogen gas and/or hydrogen-free gas from the conduit 80.

A second conduit 90 for circulating hydrogen-free gas (i.e., gas having less than or equal to about 1,000 parts per million (ppm) hydrogen), preferably in communication with the hydrogen-free gas (e.g., ambient air, stored nitrogen, argon, and the like), includes an orifice 94 at one end. A circulation pump 96 may be connected to conduit 90 for flowing air through orifice 94 and into mixing tube 100. Preferably, the hydrogen-free gas is at ambient pressure such as for example, air drawn from outside the system 10. In the event that the system 10 is enclosed, it is preferred that the hydrogen-free gas, e.g., air, is drawn from outside the enclosure 26.

The orifices 86, 94, which can comprise any number of articles, can individually be any design, orientation, and geometry capable of receiving the respective gas, and causing the gases to substantially uniformly mix within mixing tube 100. The orifices 86, 94 are calibrated and may be different (design, geometry, size, amount, and the like) for each respective conduit 80, 90 to enable the proper mixture of the hydrogen-free gas and the hydrogen gas and to attain the desired concentration. Preferably, the orifices 86, 94 are diametrically opposed such that the simultaneous flow of hydrogen-free gas and the hydrogen gas into the mixing tube 100 results in passive (i.e., without the use of mechanical components), uniform intermixing of the hydrogen gas and hydrogen-free gas. It has been found that the diametrically opposed orifices 86 and 94 are effective to eliminate gas stratification. Where the conduits 80, 90 include more than one orifice, it is preferred that the orifices are disposed along the same plane and are diametrically opposed to one another. In this manner, a uniform mixture of the hydrogen-free gas and the hydrogen gas fluidly communicates with the hydrogen gas detector 74 eliminating false readings due to non-uniformity of the gas mixture. In addition or alternative to diametrically opposing the orifices, uniform mixing can further be attained with the use of barriers, fans, and the like.

The hydrogen gas detector 74 is preferably capable of detecting at least 1% by volume of hydrogen in a gas mixture and, upon such detection, capable of producing a signal corresponding to the concentration of hydrogen. The hydrogen gas detector 74 detects hydrogen gas present in the atmosphere surrounding the detector 74. Thus, the hydrogen gas detector 74 can be used to indicate the presence of a hydrogen gas leak within the fuel system 10. Suitable hydrogen gas detectors are commonly available. These detectors include, but are not limited to, platinum catalyst type hydrogen gas detectors such as, for example, part number TGS813 commercially available from Figaro USA, Inc., Glenview, Ill.

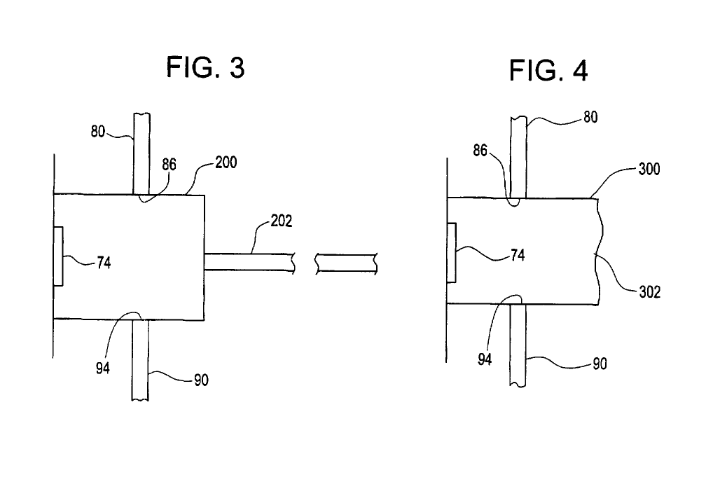

In another embodiment, the mixing tube 200 is enclosed as shown in FIG. 3. Here, the hydrogen gas detector 74 is positioned within the mixing tube 200. Conduits 80, 90 are in fluid communication with the mixing tube 200 and arranged to ensure uniform mixing of hydrogen-free gas and hydrogen gas. Preferably, the orifices 86, 94 of the conduits 80, 90, respectively, are disposed to create a turbulent gas flow, thereby inducing mixing of the gases, e.g., the conduits are diametrically opposed. The mixing tube 200 can further be in fluid communication with the conduit 202, which may further include a circulation pump (not shown), or the like, to remove the hydrogen-free gas and the hydrogen gas from the mixing tube 200 during operation and/or to direct gas from within the system 10 for testing the atmosphere within the system environment. Optionally, the mixing tube 200 may include venting ports (not shown).

In yet another embodiment, the mixing tube 300 includes an open end 302 as shown in FIG. 4. The hydrogen gas detector 74 is positioned within the mixing tube 300. Conduits 80, 90 are in fluid communication with the mixing tube 300. Preferably, the orifices 86, 94 of conduits 80, 90, respectively, are diametrically opposed, e.g., in the manner shown. The open end 302 permits sampling of the system environment for hydrogen gas detection.

Those skilled in the art will appreciate, in view of this disclosure, that the mixing tube can take on many shapes, sizes and conduit configurations for calibrating the hydrogen gas detector and for accurately sampling the system environment.

A process for calibrating the detector 74 includes activating circulation pump 96 and flowing ambient hydrogen-free gas, e.g., air, through conduit 90 onto the detector 74. The hydrogen-free gas, at ambient pressure, is drawn into conduit 90 from outside the system 10 or enclosure 26 (or from a supply (not shown), such as a nitrogen or argon cylinder), exits orifice 94 and is discharged into the mixing tube 100, 200, 300, and onto the hydrogen gas detector 74. Preferably, the source of hydrogen-free gas is air from outside the system 10. A controller 110, in communication with the circulation pump 96 controls the flow rate or volume of the hydrogen-free gas. A signal (e.g., electrical, analog, pneumatic, and the like) is generated by the detector 74 and recorded. The signal, which is preferably an electrical signal, is used to set the zero check, i.e., baseline. The zero check is an indication that there is no detectable level of hydrogen. It is preferred that the ambient hydrogen-free gas is discharged onto the detector 74 for a period of time and flow rate effective to purge any traces of hydrogen gas from the detector before setting the zero check. Moreover, it is preferred that a steady state for the electrical signal be reached.

After the zero check or baseline has been established, circulation pump 88 is activated to flow a known quantity of hydrogen gas from airspace 64. The hydrogen gas is discharged from conduit 80 through orifice 86 and into the mixing tube 100, 200, 300. The hydrogen gas mixes in the mixing tube with the hydrogen-free gas to form a uniform hydrogen/hydrogen-free gas mixture with a known concentration of hydrogen determined by the flow rates for the hydrogen-free gas and the hydrogen gas. The control gas and hydrogen gases are at the same or substantially the same ambient pressure to insure mixing accuracy.

The percentage of hydrogen gas in the mixture may be further regulated by the flow rates or volumes generated by the circulation pumps and controlled by the controller 110. The signal generated by the hydrogen detector 74 is then recorded and used to calibrate the detector signal to the known amounts of hydrogen gas in the mixture. Preferably, the percentage of hydrogen in the mixture is varied in order to more finely calibrate the detector. For example, the detector could be calibrated at 0, 2 and 4 volume percent (vol %) hydrogen levels. Preferably, the detector is calibrated at a 1 vol % hydrogen level. Periodic calibration of the hydrogen gas detector may be employed to ensure accuracy and sensitivity for detecting hydrogen gas in the system.

The amount of hydrogen gas mixed with the hydrogen-free gas in the mixing tube 100 can readily be calculated from the hydrogen and hydrogen-free gas flow rates or volumes set by the controller 110. An algorithm can then be used to program the controller 110. The controller includes the hardware and software to run the calibration process and make adjustments to the signals generated by the detector. Preferably, the calibration data, e.g., electrical signals, are stored in a non-volatile memory and readily accessed by the controller 110. The controller hardware and software can be programmed to operate the circulation pumps, valves, and other flow regulators, in the manner described and automatically calibrate the hydrogen gas detector 74 at selected intervals. Consequently, the hydrogen detector can accurately monitor the amount of hydrogen gas in the enclosure.

The process for operating a hydrogen gas detector in an electrochemical cell system, comprises: automatically calibrating the hydrogen gas detector with a controller, and automatically sampling an environment of the electrochemical cell system with the calibrated hydrogen gas detector. In the event that a hydrogen gas leak is detected, an operator or a control system can be utilized to assess the extent of the leak and employ an appropriate actions, e.g., repair leaks, purge the enclosure, shut down the system, and the like. For example, the process can comprise determining the amount of hydrogen gas in the environment, shutting down the electrochemical cell system, and/or purging the electrochemical system if the amount of hydrogen gas exceeds a selected amount.

The method for operating an electrochemical system comprises: reacting water in an electrolysis cell to produce hydrogen gas and oxygen gas, separating the hydrogen gas from water in a hydrogen/water separation device, and sampling the environment of the electrochemical system for hydrogen concentration with a calibrated hydrogen gas detector as detected above.

Due to various governmental and/or industry regulations, monitoring of hydrogen concentration in an environment (e.g., in an enclosure) either using hydrogen gas or producing hydrogen gas is required. As discussed above, accurate monitoring can be difficult. time consuming,. and expensive. Advantageously, use of the hydrogen gas detecting device and calibration method disclosed herein, e.g., the use of hydrogen-free gas, such as air, and hydrogen gas at or about ambient pressure eliminates the need for expensive pressure regulators or controls, manual calibration, and simplifies the hydrogen gas monitoring process. Moreover, the need for an operator to manually and periodically calibrate a hydrogen gas detector is eliminated.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed as the best mode contemplated for carrying out this invention.

1. A hydrogen gas detector calibration system, comprising:
a mixing tube;
a first conduit in fluid communication with a hydrogen-free gas, wherein the first conduit comprises a first orifice in fluid communication with the mixing tube;
an electrolysis cell for generating hydrogen gas;
a second conduit in fluid communication with the hydrogen gas, wherein the second conduit comprises a second orifice in fluid communication with the mixing tube; and
the hydrogen gas detector in fluid communication with the mixing tube.

2. The hydrogen gas detector calibration system of claim 1, further comprising:
a first flow regulator in operable communication with the first conduit;
a second flow regulator in operable communication with the second conduit; and
a controller in operable communication with the first and second flow regulator.

3. The hydrogen gas detector calibration system of claim 1, wherein the mixing tube comprises a container with at least one open end.

4. The hydrogen gas detector calibration system of claim 1, wherein the mixing tube comprises a closed container, and wherein the hydrogen detector is disposed within the closed container.

5. The hydrogen gas detector calibration system of claim 4, wherein the electrochemical cell system further comprises an enclosure and wherein the mixing tube further comprises a third conduit in fluid communication with the closed container and an environment within the enclosure.

6. The hydrogen gas detector calibration system of claim 1, wherein an outlet of the first orifice is disposed in a location diametrically opposed to an outlet of the second orifice.

7. The hydrogen gas detector calibration system of claim 1, further comprising a hydrogen/water separation device in fluid communication with the electrolysis cell, wherein a gas portion of the hydrogen/water separation device is in fluid communication with the second conduit.

8. A process for calibrating a hydrogen gas detector, comprising:
introducing hydrogen-free gas to the hydrogen detector, wherein the hydrogen gas detector generates a first signal;
introducing a known quantity of hydrogen gas from a hydrogen/water separator to the hydrogen gas detector, wherein the hydrogen gas detector generates a second signal corresponding to a concentration hydrogen; and
calibrating the hydrogen gas detector based upon the first and second signals.

9. The process according to claim 8, further comprising mixing the hydrogen gas with hydrogen-free gas prior to introduction to the hydrogen gas detector, and wherein the mixture of the hydrogen gas and the hydrogen-free gas has a known hydrogen concentration.

10. The process according to claim 8, wherein the hydrogen gas and the hydrogen-free gas are at about ambient pressure.

11. A process for operating an electrochemical system, comprising:
calibrating a hydrogen gas detector by passing a hydrogen-free gas through a first conduit to the hydrogen detector, wherein the hydrogen gas detector generates a first signal;
flowing a known quantity of hydrogen gas from a hydrogen/water separator through a second conduit to the hydrogen gas detector, wherein the hydrogen gas detector generates a second signal corresponding to a percentage of the hydrogen gas in the mixture; and
calibrating the hydrogen gas detector based upon the first and second signals;
introducing water to an electrolysis cell;
producing hydrogen;
separating hydrogen from water in the hydrogen/water separator;
introducing environmental gas disposed around electrochemical system components to the hydrogen gas detector; and
determining the hydrogen concentration in the environmental gas.

12. The process according to claim 11, wherein the calibration of the hydrogen gas detector further comprises mixing the hydrogen gas with hydrogen-free gas prior to introduction to the hydrogen gas detector, and wherein the mixture of the hydrogen gas and the hydrogen-free gas has a known hydrogen concentration.

13. The process according to claim 11, further comprising introducing hydrogen and oxygen to a fuel cell stack and generating electricity.

14. The process according to claim 11, wherein calibrating the hydrogen gas detector further comprises generating additional signals, wherein each one of the additional signals corresponds to a different percentage of the hydrogen gas, and calibrating the hydrogen gas detector with the additional signals.

15. The process according to claim 11, wherein the hydrogen gas and the hydrogen-free gas are at about ambient pressure.

16. The process according to claim 11, purging the electrochemical system if the hydrogen gas concentration exceeds a selected amount.

17. A process for operating a hydrogen gas detector, comprising:
automatically calibrating the hydrogen gas detector with a controller, wherein calibrating the hydrogen gas detector comprises exposing the hydrogen gas detector a hydrogen-free gas to determine a baseline, directing hydrogen gas from an electrochemical cell to a mixing tube to form a mixture having a known hydrogen concentration, exposing the hydrogen gas detector to the mixture to generate a signal corresponding to the known hydrogen concentration, and adjusting a reading of the hydrogen gas detector based upon the known concentration of hydrogen gas in the mixture; and
automatically sampling an environment around the electrochemical cell system with the hydrogen gas detector.

18. The process according to claim 17, wherein the hydrogen-free gas and the hydrogen gas are at ambient pressure.

19. The process according to claim 17, wherein the hydrogen-free gas comprises air.

20. The process according to claim 17, further comprising directing the hydrogen gas from the electrochemical cell, through a hydrogen/water separation device and to the mixing tube.
